(19) United States
(12) Patent Application Publication
(10) Pub. No.: US 2004/0134059 A1
(43) Pub. Date: Jul. 15, 2004

(54) Method for fixing at least a guiding insert between two coaxial tubes, in particular in a motor vehicle anti-roll device

(76) Inventors: Alain Berthellemey, Giffaumont Champaubert (FR); Denis Minguet, Vitry-Le-Francois (FR); Daniel Valin, Saint Armand Sur Fion (FR)

Correspondence Address: GREENBLUM & BERNSTEIN, P.L.C., 1950 ROLAND CLARKE PLACE, RESTON, VA, 20191, US

(21) Appl. No.: 10/380,041

(22) PCT Filed: Sep. 5, 2001
(86) PCT No.: PCT/FR01/02753

(30) Foreign Application Priority Data
Sep. 12, 2000 (FR) 00/11608

(51) Int. Cl. B23P 11/00

(52) U.S. Cl. 29/525.01

(57) ABSTRACT

Method of mounting at least one guiding insert between two coaxial tubes including mounting the at least one guiding insert onto an inner tube, wherein the at least one guiding insert includes an outer diameter, inserting the inner tube and the at least one guiding insert into an outer tube up to a selected position, wherein a clearance is maintained between a portion of the outer diameter of the at least one guiding insert and the inner diameter of the outer tube at the selected position, and securing the at least one guiding insert to the outer tube.

The invention relates to the assembly of devices for motor vehicle suspensions, such as anti-roll devices.

In the invention disclosed in the recent international patent PCT WO97/47486, the anti-roll device is formed of two coaxial tubes partially encased one inside the other. The inner and outer tubes are connected together by two guiding inserts. Each insert has an active part, such as an elastomer ring or roller or bearing. This active part has a generally hollow cylindrical shape and is contained between two metal ferrules, one inner and the other outer. Each ferrule is intended to be fixed to a tube.

Taking account of the practical situation of the assembly of the two tubes with the two inserts, the current option consists in:

first of all sliding the two inserts over the inner tube of small diameter by force, in such a manner that they are fixed to this tube by their inner ferrule, and

inserting by force part of the inner tube, carrying the inserts, into the outer tube of larger diameter until the inserts reach a selected position in that outer tube.

This requires a high level of precision in the manufacture of the tubes.

Indeed, a problem arises when it is desired to connect the tubes by two inserts. In practice, one of the ends of the outer tube is narrowed and the inserts can only be inserted from the same side of the outer tube. Thus, once the second insert is engaged in the outer tube, the first insert previously inserted cannot be held and kept in position, as it becomes inaccessible. This problem arises even with one insert, when this is to be fixed in a position remote from the accessible end of the outer tube.

Moreover, various imperatives must be obeyed:

the active part of the insert must not be compressed nor sheared during fixing in the outer tube;

the active part of the insert may comprise a material whose properties or dimensions may deteriorate if it is subjected to excessively high temperatures;

fixing of the inserts in the outer tube must permit the transmission of high cyclical forces.

The present invention has just improved the situation.

It proposes to this end a method of fixing at least one guiding insert between two coaxial tubes, in particular in conditions where the insert becomes inaccessible. The guiding insert preferably has an annular active part surrounded externally by a metal sleeve (a ferrule in fact) which adheres thereto in order to prevent any slippage between the active part and its sleeve.

The invention is based therefore on a method having the following stages:

a) first fixing each insert about an inner tube, and

b) inserting a part of the inner tube, bearing the insert, into an accessible end of an outer tube until it reaches a selected position in this tube.

According to an important feature of the invention, the method comprises a preliminary step consisting in:

a1) shaping each insert so that it has an outer diameter which is slightly smaller than the inner diameter of the, outer tube, in order to permit translation with clearance of the insert in the tube, from its accessible end at least as far as the aforesaid selected position,

whereas the method is continued with the following steps:

c) make each insert thus slide into the tube as far as its selected position, and

d) fix in the said position each insert in the tube.

The fixing of each insert on the small-diameter tube may be effected by any means known, in particular shrinking on.

On the other hand, the fixing of each insert in the large-diameter tube may be effected by any means capable of withstanding the forces exerted and which does not cause deterioration of the properties of the insert, e.g. by soldering, riveting, crimping, adhesion, or even magnetic shaping, as will be seen below.

Clearance is intended to mean a gap typically between 0.01 and 0.3 mm. For some specific applications, a clearance of up to 5 mm may be provided. This allows for a relatively wide tolerance over the inner diameter of the outer tube.

According to an optional advantageous feature of the invention, the axial length of the active part of each insert is less than that of its sleeve. Thus the outer sleeve of the insert extends axially beyond the active part of the insert, and this extension of the sleeve is disposed, during stage c), in the selected position. The insert is therefore fixed to the outer tube by this extension of the sleeve.

The extension may be formed on one side of the active part of the insert, or on both sides.

Advantageously, a further operation known as elimination of clearance may be provided, consisting during stage d) of reducing locally the diameter of the outer tube in the selected position, e.g. by embossing, in order on the one hand to keep each insert substantially in position before its final fixing in the large-diameter tube, and on the other hand to improve the fatigue-resistance of the assembly of tubes/inserts even for the initial clearances of a few millimetres.

Further features and advantages of the invention will appear from the detailed description given below and from the attached drawings, which show:

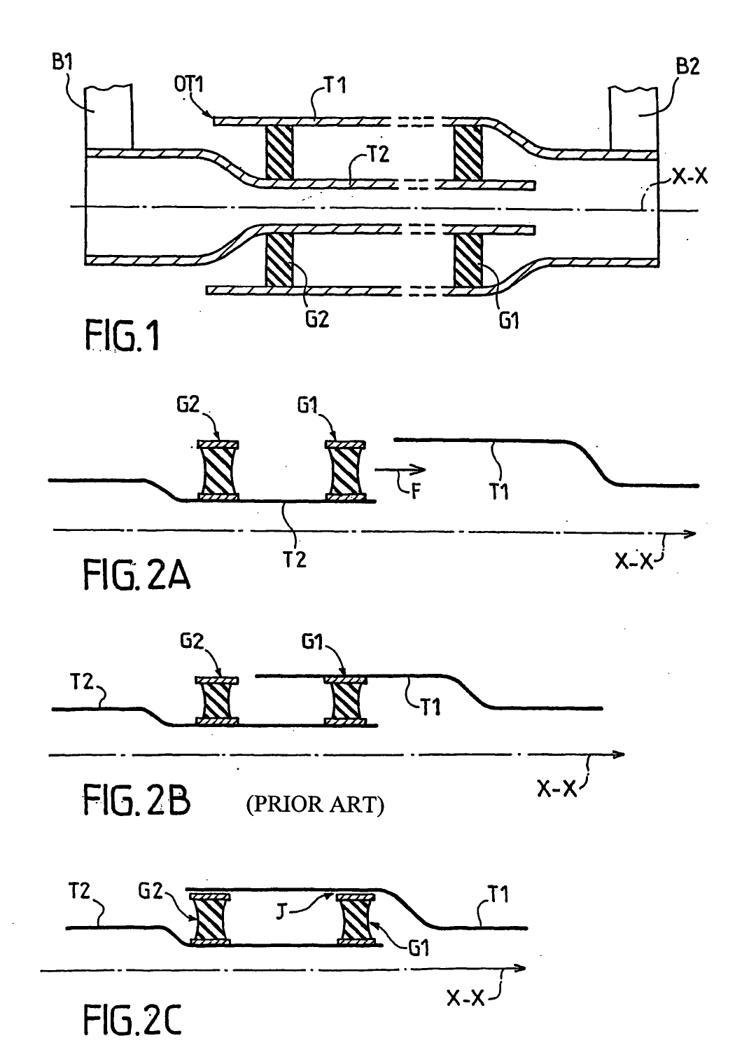

FIG. 1 shows diagrammatically a longitudinal section view of an anti-roll device for rear suspension train for motor vehicle, having two tubes T1 and T2 encased one in the other and connected by guiding inserts G1 and G2;

FIGS. 2A and 2B show diagrammatically an anti-roll device of the type shown in FIG. 1, with two consecutive stages of a method of assembly according to the prior art;

FIG. 2C shows diagrammatically an anti-roll device of the type shown in FIG. 1, assembled by a method according to the present invention;

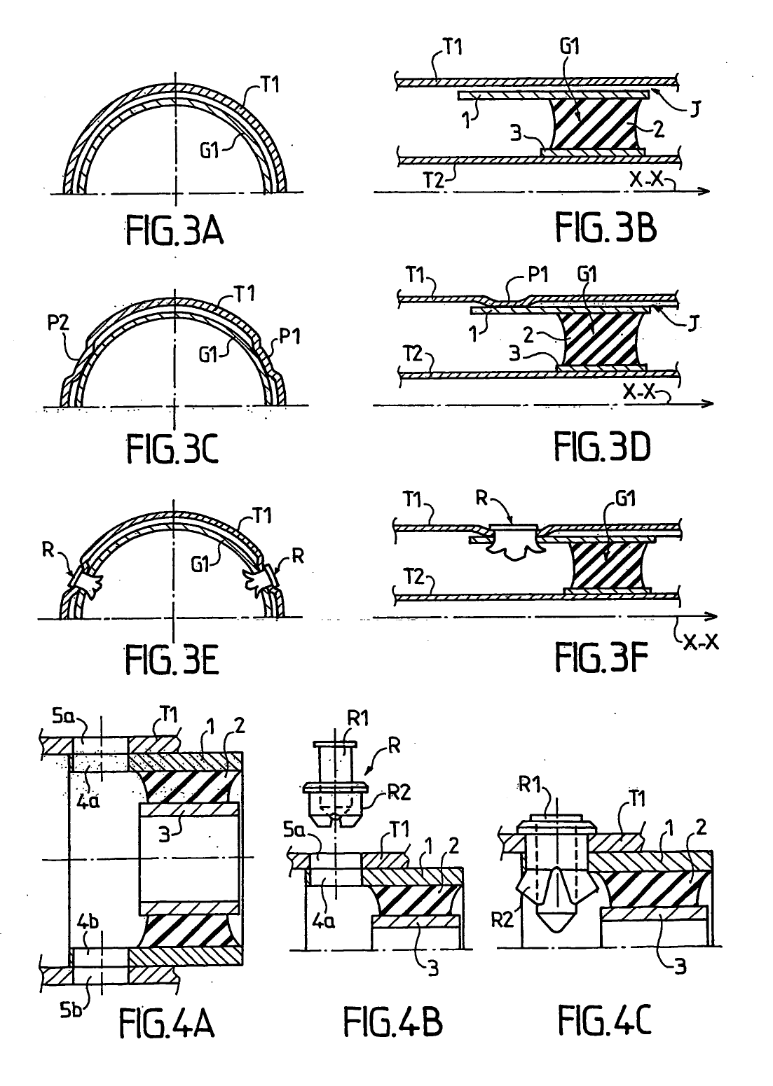

FIGS. 3A, 3C and 3E show diagrammatically views in cross-section of an assembly according to the invention at different stages of fixing of an insert by riveting, according to a preferred embodiment, and FIGS. 3B, 3D and 3F show diagrammatically views in longitudinal section of the anti-roll device during the same stages;

FIGS. 4A, 4B and 4C show in more detail views in longitudinal section of the assembly at different stages of fixing of an insert by riveting;

FIGS. 5A, 5B and 5C show partially an assembly at different stages of fixing of an insert by soldering;

FIG. 5D shows partially an anti-roll device equipped with an insert fixed by laser soldering;

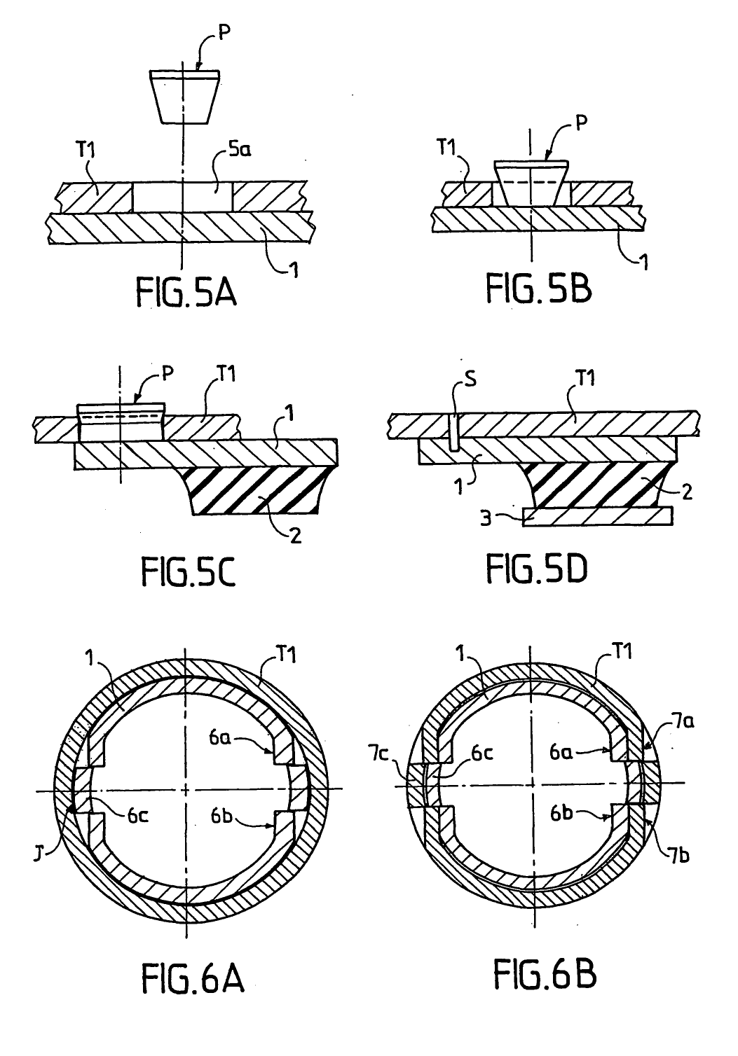

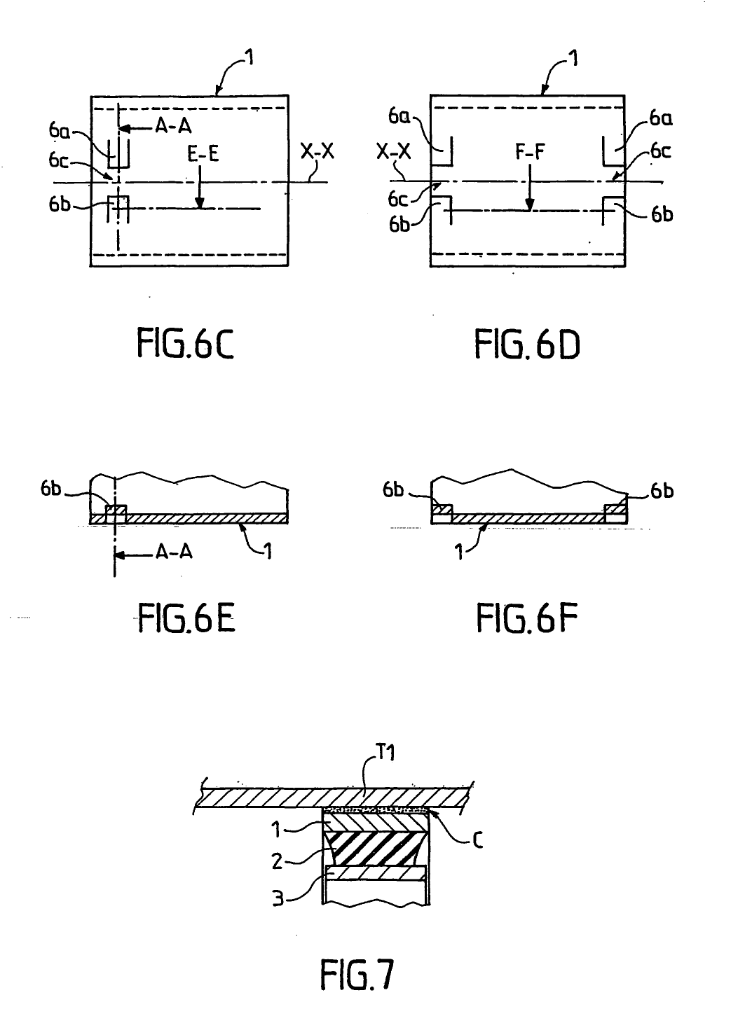

FIG. 6A shows partially, in cross-section (section line A-A in FIG. 6C), an anti-roll device equipped with an insert having a sleeve shaped to be fixed by crimping to the tube T1 which surrounds the same;

FIG. 6B shows partially the device according to FIG. 6A with the insert in its selected position, crimped to the outer tube;

FIGS. 6C and 6E show respectively a view in front elevation and in longitudinal section (line E-E of FIG. 6C) of the insert of FIGS. 6A and 6B, according to a particular embodiment;

FIGS. 6D and 6F show respectively a view in front elevation and a view in longitudinal section (line F-F of FIG. 6D) of the insert according to FIGS. 6A and 6B, according to a modification; and

FIG. 7 shows partially an anti-roll device equipped with an insert fixed by adhesion to the tube T1.

The drawings contain essentially elements of a certain character. They may therefore not only contribute to a better understanding of the description, but may also contribute to the definition of the invention it necessary.

We refer first of all to FIG. 1 in order to describe an anti-roll device for a motor vehicle suspension. This device comprises a first outer tube T1 of large diameter, in which is encased a second inner tube T2 of small diameter. These two tubes are substantially coaxial and are connected together by guiding inserts G1 and G2. In the example shown in FIG. 1, the anti-roll device has two guiding inserts.

However, in other modifications, only one insert can be provided.

The guiding inserts G1 and G2 are preferably formed as substantially circular rings, whose inner and outer faces are fixed respectively to the inner tube T2 and the outer tube T1.

In the embodiment described in the patent application PCT WO97/47486, the guiding inserts G1 and G2 have active parts in the form of rings of an elastomer material (e.g. rubber) which are connected to two metal inner and outer ferrules. In a modification disclosed in the patent application FR 00 02706, the active part of at least one insert is in the form of a bearing (e.g. a needle or ball bearing), whereas the active part of another insert is in the form of a ring of elastomer material.

The free ends of the two tubes are connected to oscillating arms B1 and B2 on which are mounted wheel-bearing knuckles (not shown).

Such a structure is described in detail in the published patent application PCT WO97/47486 and in the non-published FR 00 02706. To this end, the contents of the above patent applications should be considered as forming an integral part of the present description.

It will be seen from FIG. 1 that the end of the tube T1, connected to the arm B2, is of a substantially narrowed diameter. This particular shape of the tube T1 does not permit the insertion of guiding inserts G1 and G2 except by its open end OT1 (side of the arm B1 in the embodiment shown in FIG. 1).

We now refer to FIG. 2A, which shows the upper half of the anti-roll device shown in FIG. 1, in a first stage of a process of fixing the inserts G1 and G2 of the prior art.

As a preliminary measure, the guiding inserts G1 and G2 have been shrunk on to the tube T2 of small diameter. In the stage shown in FIG. 2B, the inner tube T2, having inserts G1 and G2, is inserted by force (arrow F) into the outer tube T1 along its axis X-X.

The insertion by force of the inserts G1 and G2 in the tube T1 carries the risk of damaging the active parts of the guiding inserts. It would therefore be necessary to accompany the insertion of the inner tube T2 by pushing on the outer and inner ferrules. But obviously, once the insert G2 has been inserted, the first insert G1 inserted previously is no longer accessible.

Referring to FIG. 2C, according to an important feature of the invention, slight clearance J is provided between the guiding inserts and the outer tube T1.

We now refer to FIGS. 3A to 3F in order to describe the fixing of an insert G1 according to a preferred embodiment of the present invention.

In particular, in the detailed view of FIG. 3B, a guiding insert G1 has an active part 2, e.g. a rubber ring, whose inner face is connected to an inner ferrule 3, which is made of metal in the example described. This ferrule 3 is shrunk on to the small-diameter tube T2.

The outer surface of this active part 2 is connected to an outer ferrule 1, which is made of metal in the example described. This ferrule 1 is opposite the inner face of the large-diameter tube T1, with a clearance J separating them.

It will be noted in FIG. 3B that, unlike the inner ferrule 3, the outer ferrule 1 extends axially beyond the active part 2, so that this active part 2 is substantially offset relative to the centre of the insert G1.

FIGS. 3A and 3B show in particular the stage c) mentioned above which corresponds to the insertion of the insert G1 into the tube T1 and sliding thereof into a selected position P1 (FIG. 3D). This sliding is ensured by the clearance J in translation. Thus the clearance J between the tube T1 and the outer ferrule 1 is provided along the tube T1, from its aperture OT1 to at least the selected position P1.

As is shown in FIGS. 3C and 3D, the outer tube T1 has an elimination of clearance in the selected position P1. This elimination consists in local narrowing of the diameter of the outer tube T1 over only part of its length and at plural points on its circumference.

This elimination can be effected by embossing with a press after the stage of positioning of the insert in the tube in its selected position.

It can be seen from FIG. 3D that it is the extension of the outer ferrule 1 beyond the active part 2 of the insert which is opposite the position P1 (in which the clearance J has been eliminated). In this position P1, a rivet R (FIG. 3F) is inserted into the tube T1 and in the extension of the ferrule 1 in order to rivet the guiding insert G1 to the tube T1.

With reference to FIG. 3E, at least two for the insert G1 to the tube T1 fixings are provided in the example shown.

The number of fixings depends on the forces (particularly torsion) intended to pass between the tube T1 and the insert.

With reference to FIGS. 4A to 4C, it is provided to form in one operation the apertures 4a in the outer ferrule 1 and the apertures 5a in the tube T1 at the position P1 where the clearance J is substantially eliminated. As the apertures 4a and 4b of the ferrule 1 therefore coincide with the apertures 5a and 5b in the tube T1, the rivet R is ready to be inserted into the apertures 4a and 5a of the ferrule and the tube.

In a preferred embodiment, the rivet R comprises a cruciform split ring R2, into which a point R1 is forcibly inserted. With reference to FIG. 4C, the inclined plates of the split ring R2 spread apart to allow the end of the point R1 to pass inside the tube T1. The guiding insert is thus riveted to the tube T1.

Advantageously, the elimination of clearance J in the position P1 makes it possible substantially to reduce shearing of the rivet during operation of the anti-roll device. Furthermore, it is advantageous to leave the point R1 in the split ring R2 in order to limit this shearing force further. The point R1 therefore remains trapped in the ring R2.

We now refer to FIGS. 5A to 5C in order to describe a modification of the above-described embodiment according to which the insert is fixed by soldering.

An aperture 5a is formed in the selected position P1 in the tube T1. As in the previous embodiment, the active part 2 of the insert is offset, leaving an extension of the outer ferrule 1 opposite the aperture 5a. A soldering slug P is inserted into the aperture 5a of the tube T1 until it comes into contact with the extension of the outer ferrule 1.

Referring to FIG. 5B, the slug P is preferably conical in shape and flared towards the exterior of the tube T1. The slug P is positioned in the aperture 5a of the tube T1, preferably without touching the edges of this aperture. Thus the solder is well formed between the slug and the ferrule 1, but not with an edge of the aperture 5a.

With reference to FIG. 5C, the temperature of the slug P is high to solder the ferrule 1 to the tube T1. It will be noted that the slug P satisfactorily fills the aperture 5a of the tube.

The risks of caulking are thus limited in order that the guiding insert in the anti-roll device stands up well to use.

The active part of the insert (e.g. formed of elastomer material or taking the form of a bearing) may prove sensitive to an increase in temperature. Advantageously, this active part is offset relative to the selected position P1, which makes it possible to limit the risk of deterioration due to the increase in temperature necessary to carry out soldering.

In the modification of this embodiment shown in FIG. 5D, the tube T1 does not have an aperture. On the other hand, a plurality of solder spots S or a continuous circumferential solder line is provided, soldering being effected by heating due to the incidence of a laser beam on the outside of the tube T1. The region thermally affected by the laser solder is deep, but advantageously narrow along the axis X-X, which makes it possible to avoid damaging the properties of the insert.

We will now refer to FIGS. 6A to 6D in order to describe a method of fixing an insert by crimping, respectively in two consecutive stages of this process.

FIG. 6A shows a cross-section of the extension of the outer ferrule 1 of the insert positioned in the tube T1 before crimping.

Preferably, the extension of the ferrule 1 has at least a pair of notches 6a, 6b pressed towards the exterior of the ferrule 1 (towards the axis X-X). In the embodiment shown in FIGS. 6B and 6C, two pairs are provided disposed respectively on one side and the other of the axis X-X.

The notches 6a, 6b of one pair have been preliminarily formed on either side of a medial plane of the ferrule 1 by simultaneous cutting out and pressing by means of sharp tools. Thus the insert can slide into the tube T1, since clearance J in translation is always provided between the inside of the tube T1 and the non-deformed part 6c of the ferrule 1 up to the selected position P1.

In an embodiment shown in FIGS. 6A and 6B, the notches 6a and 6b are oriented so that they are positioned to the right of punches located outside the outer tube T1. These punches then cut out and press the outer tube in order to form two tongues 7a and 7b as is shown in FIG. 6B. The tongues 7a and 7b bear on the notches 6a and 6b previously formed in the ferrule 1 of the insert. The system of tongues and notches therefore locks the insert relative to the outer tube simultaneously in both axial, radial and circumferential directions.

As a modification, the notches 6a, 6b are not formed in the insert prior to crimping.

According to this modification, after sliding the insert into the tube as far as its selected position, cut-outs and pressing are carried out simultaneously on the tube T1 and on the ferrule 1 in order to form at the same time the notches 6a, 6b and the tongues 7a, 7b which at the same time come to bear on the notches.

This embodiment requires particularly sharp tools capable of shearing a double thickness of metal.

Obviously, the present invention is not limited to the embodiment described above by way of example, but extends to other modifications.

Thus it will be noted that the guiding insert can be fixed by any other means whereby deterioration of the properties of its active part can be avoided. For example, referring to FIG. 7, the outer ferrule 1 of the insert can be fixed to the inner face of the tube T1 by adhesion. A preferred embodiment would consist in providing an aperture in the tube T1, in the above-mentioned selected position, through which the adhesive C is inserted.

In general, it is preferable to eliminate the clearance J in the selected position, whatever mode of fixing is provided. This makes it possible both to select tubes T1 whose tolerance over the inner diameter is relatively wide and to improve the fatigue-resistance of the fixings between tubes and inserts.

As described above, the active part of the insert may comprise a ring of elastomer material, or a bearing such as a roller bearing with needles or balls or any other type of roller bearing. Nevertheless, if the active part of the insert is capable of withstanding high temperatures, it may be contrived, in the embodiment according to which the insert is fixed by soldering, to insert a slug of solder to the right of the active part. In such an embodiment, the extension of the outer ferrule 1 (FIG. 5C) is no longer necessary.

Whatever the mode of soldering, the soldering power must be limited and low-energy soldering methods must be used in order to avoid damaging the active part of the insert.

In the embodiment wherein the insert is fixed by crimping, notches can be provided on only one side (FIG. 6C) or else on both sides of the active part (FIG. 6D), on either side thereof. In the latter case, the number of notches may advantageously be doubled.

The notches formed on the outer ferrule of the insert may be carried out in solid material or by cutting out as described above. It should be noted that, in the embodiment of notches formed by cutting, an extension of the outer ferrule beyond the active part is preferably contrived.

Obviously, the number of fixing points to be provided (by riveting, crimping or soldering) depends on the forces, in particular cyclical forces, passing through the guiding insert axially, radially and torsionally.

1. Method of fixing at least one guiding insert (G1, G2) between two coaxial tubes (T1, T2), in particular of an anti-roll device for a motor vehicle, of the type comprising the following stages:
a) first fixing each insert about an inner tube, and
b) inserting a part of the inner tube, bearing the insert, into an accessible end of an outer tube until it reaches a selected position in this tube,
characterised in that it comprises a preliminary step consisting in:
a1) shaping each insert so that it has an outer diameter which is slightly smaller than the inner diameter of the outer tube, in order to permit translation with clearance of the insert in the tube, from its accessible end at least as far as the aforesaid selected position (P1),
and in that the method is continued with the following steps:
c) make each insert thus slide into the tube as far as its selected position, and
d) fix in the said position each insert in the tube.

2. Method according to claim 2, characterised in that the outer sleeve of each insert is extended axially beyond an active part (2) which the insert comprises, and in that this extension of the sleeve is disposed in the selected position during stage c).

3. Method according to either of claims 1 or 2, characterised in that the insert is soldered to the outer tube (T1) during stage c).

4. Method according to claim 3, characterised in that stage d) comprises the following operations:
d1) providing in the selected position at least one aperture (5a) in the outer tube (T1),
d2) introducing a solder slug (P) into the aperture in contact with the outer face (1) of the sleeve of an insert, and
d3) raising the temperature of the slug in order to solder this insert to the tube.

5. Method according to claim 4, characterised in that during the operation d2), the slug (P) is positioned without touching the walls of the aperture.

6. Method according to claim 5, characterised in that the slug (P) is initially conical and widens towards the exterior of the outer tube (T1).

7. Method according to claim 3, characterised in that the insert is fixed to the outer tube by laser soldering.

8. Method according to claim 7, characterised in that the insert is soldered by a plurality of spots (S).

9. Method according to claim 7, characterised in that the insert is soldered along a continuous circumferential line.

10. Method according to one of claims 3 to 9, in combination with claim 2, characterised in that the insert is soldered to the outer tube (T1) by the extension of its outer sleeve (1) so as to preserve the active part against deterioration from heat.

11. Method according to either of claims 1 or 2, characterised in that the insert is fixed by riveting to the outer tube during stage d).

12. Method according to claim 11, in combination with claim 2, characterised in that the extension of the sleeve (1) of the insert is placed in the selected position during stage c) and in that stage d) further comprises the following operations:
d1) insert a rivet (R) into the outer tube in the selected position until it projects into the extension of the insert, and
d2) rivet the insert to the tube.

13. Method according to claim 12, characterised in that the rivet (R) has a split ring with inclined plates (R2) and a point (R1) capable of being inserted forcibly into the ring.

14. Method according to either of claims 1 or 2, characterised in that the insert is fixed by crimping to the outer tube during stage d).

15. Method according to claim 14, in combination with claim 2, characterised in that the outer sleeve (1) of each insert has at least one pair of notches (6a, 6b) turned down towards the inside of the sleeve (1), whereas the outer tube has, in the selected position, a pair of tongues (7a, 7b) which are substantially homologous and are capable of coming to bear against the notches (6a, 6b) in order to effect the fixing of stage d).

16. Method according to either of claims 1 or 2, characterised in that the diameter of the outer tube (T1) is reduced by magnetic shaping during stage d) in order to fix each insert.

17. Method according to one of the preceding claims, characterised in that it comprises an operation known as “elimination of clearance”, consisting in reducing locally in the selected position the diameter of the outer tube (T1) before fixing of the insert (G1) in stage d).

18. Method according to one of the preceding claims, characterised in that in stage c), at least two diametrically opposed fixing points are provided for each insert (G1) on the outer tube (T1).
